(19) United States
(12) Patent Application Publication
(10) Pub. No.: US 2010/0284543 A1
(43) Pub. Date: Nov. 11, 2010

(54) AUDIO SYSTEM WITH BONDED-PERIPHERAL DRIVEN MIXING AND EFFECTS

(76) Inventors: John Sobota, Edmonton (CA); Phillip Jacobsen, Sherwood Park (CA)

Correspondence Address: DONALD V. TOMKINS;C/O TOMKINS LAW OFFICE, 740, 10150 - 100 STREET, EDMONTON, AB, T5J 0P6, CA

(21) Appl. No.: 12/811,250

(22) PCT Filed: Jan. 5, 2009
(86) PCT No.: PCT/CA09/00011

§ 371 Date: Jun. 30, 2010

Related U.S. Application Data
(60) Provisional application No. 61/019,035, filed on Jan. 4, 2008.

(51) Int. Cl. H04S 3/00

(52) U.S. Cl. 381/2; 381/119

(57) ABSTRACT

In a system providing for delivery of audio signals from one or more source audio systems to two or more audio output sink systems, the sink systems establish duplex communication links (or bonds) to a bonding subsystem, which in turn is in duplex communication with the source audio systems. Data signals may be sent from sink systems, via the bonding subsystem, to request delivery of audio signals from selected audio source channels. In preferred embodiments, the sink systems may also request specific treatments of or modifications to audio signals to be sent to individual sinks in the sink systems. The bonding subsystem receives such treatment requests from the sink system and relays them to a matrix manager which initiates and controls the processing of source audio channels as required to comply with requests from the sink system. The matrix manager then delivers the treated or modified audio output channels to the bonding subsystem for delivery to the requesting sink systems.

### FIELD OF THE INVENTION

The present invention is directed in general to systems for distribution of audio signals, and in particular to systems for distributing audio signals from one or more audio sources to one or more audio signal destinations.

### BACKGROUND OF THE INVENTION

It is common for modern cinemas to use “surround sound” audio systems that use multiple speakers arrayed around the theater to enhance moviegoers' enjoyment of the movie being screened. Many electronics companies now manufacture “home theater” systems which attempt to provide cinema-quality audio and video in a private home or other non-cinema setting. The audio system in a home theater system can be fairly simple or quite complex, depending on budget and desired performance criteria. A simple home theater system might have only left and right speakers plus a subwoofer, while a fancier system might have seven or more speakers with one or more subwoofers. The Dolby® Digital 5.1 system, which may be considered the benchmark for acceptably high-quality audio in a home theater system, incorporates five speakers (left, left rear, center, right center, and right) plus a subwoofer.

A home theater system can be custom-built from selected system components (as is commonly the case for “high end” systems). A home theater system may alternatively be purchased in kit form, often referred to as “home theater in a box” (or “HTIB”). HTIB systems are typically fairly simple for users to set up and operate; however, they generally do not provide audio quality comparable to that available from more expensive custom systems. This lower audio quality common to HTIB systems may be due in some cases to the use of a small number of speakers, and/or due to inherent systemic obstacles to optimal set-up to accommodate particular home theater settings.

On the other hand, even though custom home theater systems are typically capable of being set up to optimize audio quality to suit the particular characteristics of a given home theater setting, it can be frustratingly difficult for the user to do so. This is typically due to the complexity of the custom system's physical set-up as well as the need to program a large number of variable parameters into the system (for example, speakers' operational characteristics, relative locations within the home theater setting, and distances from the system's audio source) in order to achieve optimal audio performance. However, not all users will have the technical knowledge and/or patience required for these tasks, and as a result, users may experience only sub-optimal audio quality from a system that is in fact capable of considerably better performance.

For these reasons, there is a need for means adaptable for use in audio systems (such as but not limited to audio systems for home theater systems) requiring delivery of audio signals to multiple audio output destinations (such as but not limited to speakers), in which audio system performance may be optimized to suit a given installation or physical setting without requiring complicated set-up procedures or specialized technical knowledge on the part of system users. The present invention is directed to this need.

### BRIEF SUMMARY OF THE INVENTION

In general terms, the present invention teaches a system for managing audio signals which provides for bi-directional (or ‘duplex’) communication between one or more audio sources and one or more audio output destinations (or ‘sinks’) such as speakers or headphones, such that data signals can be sent from a sink to request delivery of audio signals from selected source audio channels. In preferred embodiments, the sink systems can request specific treatments of or modifications to the source audio signals to be sent to the sink (or to a ‘sink system’ comprising multiple sinks). In particularly preferred embodiments, a ‘request’ by a sink system may be effected in the form of a transmission of control data corresponding to particular ‘attributes’ of the sink system and its component sinks (see the Glossary section of this patent specification for definition of ‘attributes’ and other terminology, as used herein). The allocation of specific source audio signals to specific sinks, and any treatment or modification of source audio signals prior to delivery to the sinks, is determined in accordance with predetermined rules or protocols, based on the attributes or other information transmitted in the requests from the sink systems.

Accordingly, the system of the present invention facilitates the set-up of any multiple-source, multiple-output sound system for optimal audio quality, without requiring the user to carry out any complicated set-up procedures. The system automatically receives and gathers information pertaining to the sink systems, and based on that information determines appropriate audio signal treatment and allocation for optimal overall performance and audio quality of the sound system.

The source audio management system of the present invention incorporates a ‘bonding subsystem’ by means of which one or more sink systems can ‘bond’ to a source audio system (i.e., establish a duplex communications link with the source audio system, via the bonding subsystem, to enable transmission of an audio signal from the source audio system to the sink system). The bonding subsystem determines which source audio channels will be delivered to which sink systems, in accordance with predetermined rules or protocols.

In preferred embodiments of the invention, the bonding subsystem receives requests from the sink systems and relays them to a control means (also referred to as a ‘matrix manager’) which initiates and controls the processing or treatment of source audio channels (in a ‘mixing grid’) as appropriate in response to requests from the sink systems. The matrix manager delivers the treated or modified audio output channels to the bonding subsystem for delivery to the requesting sink systems. In a simplified alternative embodiment of the system, the source audio channels are not subject to processing prior to delivery to the bonding subsystem. In this case, the source audio channels are made directly available to the bonding subsystem, and no mixing grid or matrix manager are required.

The present invention facilitates the servicing of multiple and different sink systems with one source audio system. Subsets of sink systems can be served by the source audio system concurrently, and the nature of the service provided at any moment in time is determined by whatever sink systems are bonded at that moment. The principles of the present invention can also be adapted for use with audio systems incorporating multiple source audio systems (i.e., wherein the sink systems have a choice of source audio systems with which to bond).

### BRIEF DESCRIPTION OF THE DRAWINGS

Embodiments of the invention will now be described with reference to the accompanying figures, in which numerical references denote like parts, and in which:

FIG. 1 is a schematic layout of an audio system in accordance with a first embodiment of the present invention, configured to serve a single sink system from a single source audio system.

FIG. 2 is a schematic layout of an audio system as in FIG. 1, configured to serve two sink systems from a single source audio system.

FIG. 3 is a schematic layout of an audio system as in FIG. 2, wherein one of the two sink systems is temporarily de-bonded from the bonding subsystem in response to a request from the other sink system.

FIG. 4 is a schematic layout of an audio system as in FIG. 2, illustrating a variant configuration in which selected audio channels are delivered via simplex communications links to sink systems independent of the bonding subsystem.

FIG. 5 is a schematic layout of a variant embodiment of an audio system as in FIG. 2, illustrating the optional use of an audio signal input transfer function that produces more than one output.

FIG. 6 is a schematic layout of an audio system as in FIG. 2, wherein one of the two sink systems is temporarily muted in response to a request from the other sink system.

FIG. 7 is a schematic layout of an audio system in accordance with an alternative embodiment of the invention, in which an external source audio system is bonded to the bonding subsystem.

For simplicity, the Figures do not show amplifier blocks (as would be required to provide the gain required to boost line-level signals to speaker level). Persons of ordinary skill in the art will appreciate that such audio amplifiers would be provided as necessary.

The present invention may be adapted for use with either analog or digital audio signals or any combination thereof, so no ADC and DAC blocks are shown in the Figures. Similarly, the specific qualities of all audio signals (e.g., bit depth, sampling rate, dynamic range, compressed/uncompressed) can be virtually any specification that is desired, so these are not specified or discussed beyond this paragraph.

The specifics of the wireless and/or wired communications links are likewise not defined or illustrated in detail in the Figures or in this specification. It will be readily apparent to persons skilled in the art that the bonding subsystem must be able to establish bonds with one or more sink systems, and that these bonds must support the transmission of one or more channels of audio, plus separate control information that needs to flow in both directions. It is to be assumed that the physical wired and wireless communications subsystems meet these requirements and provide sufficient error correction and quality of service (QoS) to enable the system of the present invention to function with acceptable reliability. Technologies and methodologies for providing sufficient error correction and QoS will be within the knowledge of persons of ordinary skill in the art, including but not limited to methodologies disclosed in U.S. patent application Ser. No. 11/311,245 (Pub. No. US 2006/0153155 A1), the entirety of which is incorporated herein by reference.

### DETAILED DESCRIPTION OF PREFERRED EMBODIMENTS

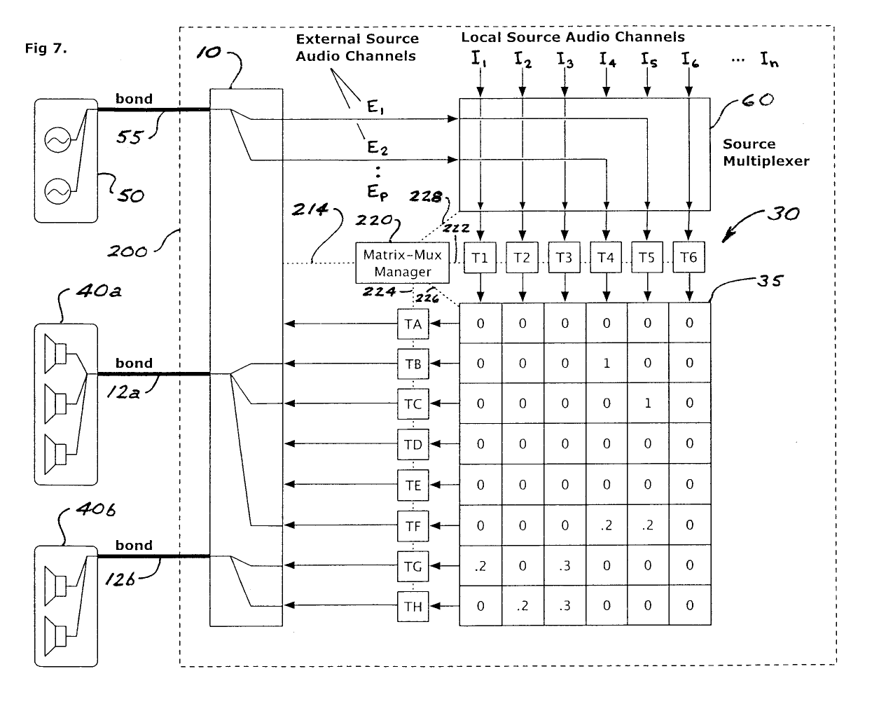

As shown in the Figures, preferred embodiments of the audio signal management system 100 (or 200, in FIG. 7) of the present invention typically comprise the following elements:
Bonding subsystem 10;
Matrix manager 20; and
Mixer matrix 30, comprising:
   “n” number of input transfer functions, labeled in the Figures as T1, T2,
   T3, etc., with numerical suffixes referable to the corresponding source audio channels I₁, I₂, I₃, etc.;
   “m” number of output transfer functions, labeled in the Figures as TA, TB, TC, etc., with letter suffixes referable to corresponding output audio channels O_{A}, O_{B}, O_{C}, etc. (note that “m” may be greater or less than “n”); and
   Mixing grid 35.

Audio signal management system 100 (or 200) may be incorporated into a flat screen television or just about any other component of an entertainment system such as a DVD/home theater receiver. A plurality of audio channels I₁ to Iₙ (from a primary source audio system) are made available to system 100. As will be described in greater detail further on in this specification, mixer matrix 30, as controlled by matrix manager 20, produces a plurality of output sink audio channels O_{A} to Oₘ which are made available to bonding subsystem 10 for selective delivery to one or more sink systems 40 (typically but not limited to speakers and/or headphones) in accordance with requests made by one or more of sink systems 40 to bonding subsystem 10.

The individual components, features, and functionalities of preferred embodiments of the audio signal management system of the present invention, as outlined above, are discussed in further detail below.

### Bonding Subsystem

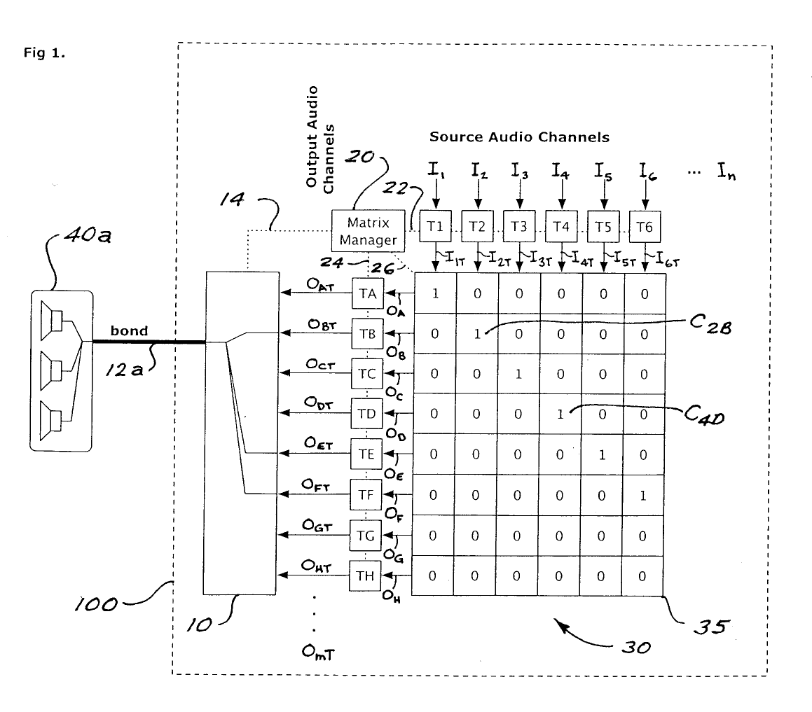

Bonding subsystem 10 is a functional block which can be analogized to a switchboard operator. When a sink system requests a bond, it effectively asks bonding subsystem 10 to create connections to specific output channels (as in FIG. 1, for example, where sink system 40a is connected to output channels O_{B}, O_{E}, and O_{F}), as determined by bonding subsystem 10 in accordance with predetermined rules. At the output, bonding subsystem 10 interfaces with the physical layer (i.e., a duplex communication solution, either wired or wireless, which provides audio signal paths for one or more output channels, plus control signaling enabling sink systems to make requests of the source audio system). Although the Figures do not indicate a functional block for the physical layer, it is to be understood that the physical layer will be required in order for a bond to exist. It is also to be understood that any sink systems bonded to bonding subsystem 10 will be ‘smart’ devices; i.e., devices capable of duplex (bi-directional) communication and thus able to both send and receive control data.

### Source Audio Channels

The system of the present invention can support any number of source audio channels. In some embodiments, there will be six source audio channels (for example, in a 5.1 system where six channels of audio are decoded from a Dolby® Digital or DTS bitstream originating from a DVD). The number of source audio channels could also be eight (as in a 7.1 system which is now common in Blu-Ray™ and HD-DVD discs). However, the number of source audio channels could be much higher if more audio is available (for instance, if a 7.1 source plus four programs of stereo music are available, which would result in a total of sixteen source audio channels).

### Mixer Matrix

In preferred embodiments, mixer matrix 30 comprises:
“n” input transfer functions (labeled T1, T2, T3, etc., with numerical suffixes referable to the corresponding source audio channels Iᵢ, I₂, I₃, etc.);
“m” output transfer functions (labeled TA, TB, TC, etc., with letter suffixes referable to corresponding output audio channels O_{A}, O_{B}, O_{C}, etc.); and
Mixing grid 35.

Matrix manager 20 controls and defines all of the parameters loaded into the transfer functions and mixing grid 35. As conceptually illustrated in FIGS. 1-6, matrix manager 20 is operationally connected to bonding subsystem 10 by communications link 14, to the input transfer functional blocks (T1, T2, T3, etc.) by link 22, to the output transfer functional blocks (TA, TB, TC, etc.) by link 24, and to mixing grid 35 by link 26.

### Sink System

The sink systems 40 are the destinations for the audio signals, and do not constitute essential elements of the present invention. Sink systems 40 typically will be speakers or headphones, but they could be virtually any devices capable of accepting an audio signal, including transducers that produce haptic effects. A sink system has one communications path back to the source audio system and has one or more sinks (i.e., audio destinations, for example, speaker drivers). A sink system does not have to be fully contained within one physical enclosure.

### Transfer Functions

The transfer functions can contain any selected combination of audio conditioning and/or effects blocks. Examples of transfer functions are equalization, dynamics compression/expansion, gating, delays, echoes, reverbs, chorusing, filters, gain levels, etc. All of the parameters for these effects are loaded into the transfer function blocks by the matrix manager. There is one set of transfer functions for the inputs (T1, T2, T3, etc.) and another completely independent set for the outputs (TA, TB, TC, etc.).

### Mixing Grid

At the center of mixer matrix 30 is mixing grid 35, a grid of coefficients C that determine how much of each input signal is mixed together to form each output signal. Coefficients C can be changed at any time and are under the complete control of matrix manager 20. For reference purposes in the Figures, the coefficients in specific cells of mixing grid 35 are designated according to their grid coordinates. For example, in FIG. 1, coefficient C_{2B} corresponds to source audio channel I₂ and output channel O_{B}, and coefficient C_{4D} corresponds to source audio channel I₄ and output channel O_{D}.

The signal for each output channel is determined as the sum of the products of the corresponding input signals and mixing grid coefficients. For example, the signal for output audio channel O_{A} (at the output edge of mixing grid 35) would be calculated as:

O_{A}=I₁*C₁A+I₂*C₂A+I₃*C₃A . . . Iₙ*C_{nA}

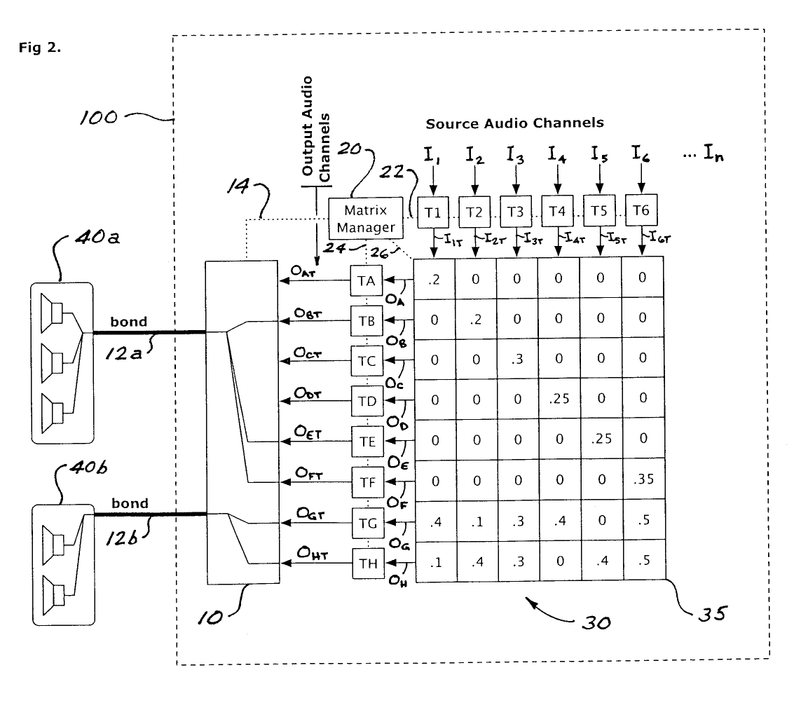

If source audio signals have been modified by input transfer functions (T1, T2, T3, etc.) before entering mixing grid 35, their post-transfer form is so designated by a “T” suffix (e.g., I_{1T}, I_{2T}, I_{3T}, etc., as referenced by way of example in FIGS. 1 and 2), and the foregoing expression of the output signal calculation would be modified accordingly.

### Output Audio Channels

After being mixed in mixing grid 35, each of the output audio channels (O_{A}, O_{B}, O_{C}, etc.) is processed by its corresponding output transfer function (TA, TB, TC, etc.) to create the final audio signals (referenced in FIGS. 1 and 2 as O_{AT}, O_{BT}, O_{CT}, etc.) for delivery to bonding subsystem 10 and routing as appropriate to the sink systems bonded to bonding subsystem 10.

As previously noted, the number “m” of output audio channels can be different from the number “n” of source audio channels. This allows, for example, a 5.1 signal to be mixed for 7.1 speakers, or a 7.1 signal to be mixed for 6.1 speakers, and many other combinations of functionality.

### Simplified Alternative Embodiments

Simplified alternative embodiments of the system may provide for selective allocation of audio signals to sink systems by bonding subsystem 10 without signal preconditioning or mixing, making it unnecessary for such embodiments to incorporate a matrix manager and mixing grid.

### Requests

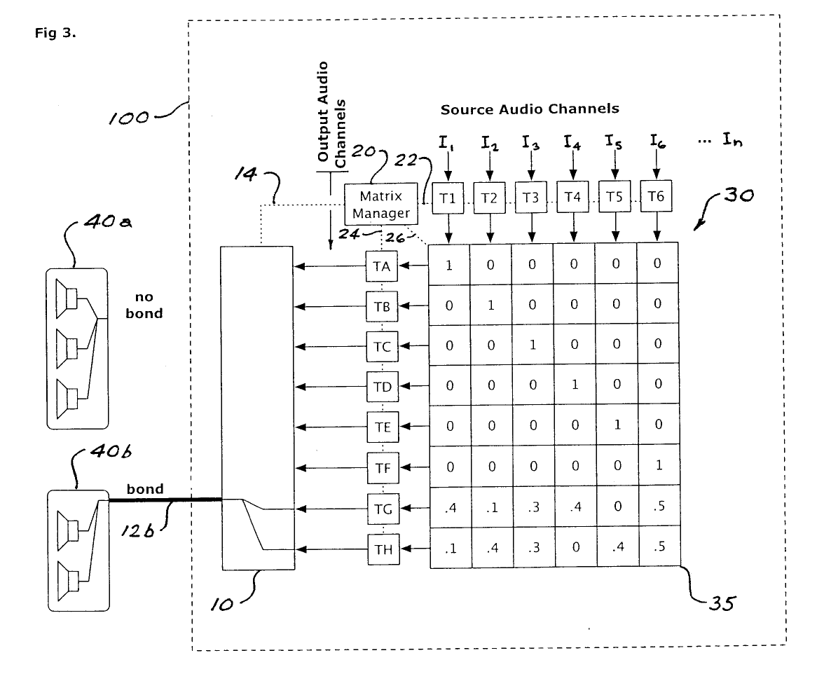

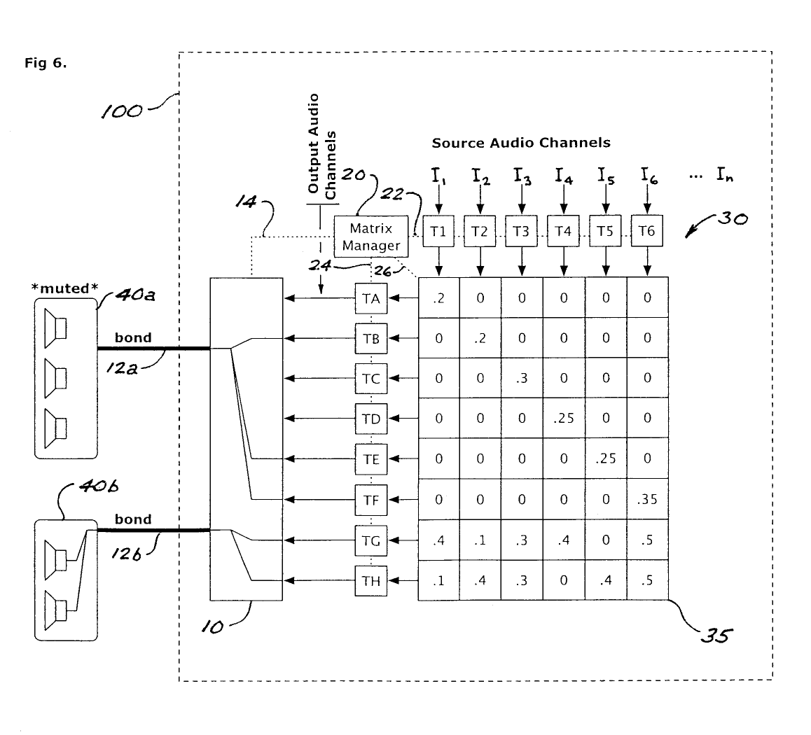

In a first embodiment of the audio signal management system of the present invention, the sink systems can make requests of the source audio system, including (but not limited to) the following examples:
Load a set of coefficients into part or all of mixing grid 35 (see discussion, below, in connection with FIG. 2);
Load a set of parameters into some or all of the transfer functions (see FIG. 2. discussion);
Drop or establish bond to one or more sink systems (see FIG. 3. discussion); and/or
Send control command to one or more sink systems (see FIG. 6. discussion).

In this embodiment, the sink systems may need to transfer comparatively large amounts of data to the source audio system (i.e., many audio output parameters and coefficients).

### Conflicts

If two or more sink systems are making conflicting requests, the matrix manager would resolve the conflicts according to a pre-established set of rules.

In a second embodiment, upon bonding each sink system would simply identify itself by type (possibly by stating several performance attributes) to the source audio system. The matrix manager, seeing the total collection of sink systems bonded along with their attributes, would select the best or optimal coefficient set and parameter set, and load those numbers into the mixing grid and transfer functions respectively. In this embodiment, the amount of control data sent by the sink systems to the source audio system would be comparatively small. Again, the matrix manager would make these decisions according to a predetermined set of rules.

In a third embodiment, the sink system(s) may request a new set of parameters and coefficients, and the matrix manager may take these requests into consideration, yet may do something somewhat (or entirely) different to optimize the overall system. Again, the matrix manager would make these decisions according to a predetermined set of rules.

In all three of the above-described exemplary embodiments, the choice of coefficients and parameters is directly or indirectly determined by the currently-bonded sink system or systems. Although the discussion relating to the Figures is primarily in the context of the first embodiment, the results shown in all of the Figures can be achieved in the context of the second and third embodiments also.

In all three above-described embodiments, the matrix manager is required to make decisions according to predetermined rules. The rules can be ‘static’ rules that are programmed into the matrix manger permanently (e.g., as firmware), or ‘dynamic’ rules over which the user of the system (or another person or system) may have control, as one might have control over preferences on a computer or television. The rules may use logical, mathematical, ladder logic, algorithms, etc., using the requests and/or attributes originating from the sink systems as inputs, and generating the coefficients and parameters as outputs. There is no limit as to the nature and number of rules that can be implemented, and the implementation of the decision algorithms to do so may be accomplished by a number of means, including artificial intelligence techniques such as neural networks, etc.

Particular embodiments and configurations of the system of the present invention will now be described with specific reference to the Figures.

FIG. 1 illustrates an audio signal management system 100 in accordance with one embodiment of the present invention, with a mixer matrix 30 that has had default parameters and coefficients loaded by the matrix manager 20 upon start-up. Subsequently, sink system 40a (which in this example incorporates three sinks) has bonded to bonding subsystem 10 via bond 12a and has requested output channels O_{B}, O_{E}, and O_{F} from bonding subsystem 10. Bonding subsystem 10 has complied, connecting the appropriate output channels to sink system 40a via bond 12a. In this example, sink system 40a had no further requests, so the coefficients in mixing grid 35 and parameters in the input transfer functions (T1, T2, T3, etc.) and output transfer functions (TA, TB, TC, etc.) were left unchanged from their start-up values. It will be noted that the particular locations of the “1” coefficients in mixing grid 35 allow the flow of source audio channel I₁ to output channel O_{A}, source channel I₂ to output channel O_{B}, and so forth. It may also be noted that if a second sink system were to bond up and request some or all of the same output channels (O_{B}, O_{E}, and O_{F}), bonding subsystem 10 would be able to do that as well (i.e., outputs can be parallel-connected to multiple sink systems, if requested).

FIG. 2 is similar to FIG. 1, except that a second sink system 40b has bonded to bonding subsystem 10 via bond 12b. Sink system 40b has requested a connection to output channels O_{G} and O_{H} (which bonding subsystem 10 has done). In addition, sink system 40b has requested new coefficients for mixing grid 35 (see new numbers in grid) and new parameters for the transfer functions (although there is no way to see this in FIG. 2). This example is for a “full” replacement of coefficients and parameters, but note that a full replacement of all coefficients and parameters is not necessary—sink systems may request only partial replacements. Since sink system 40a had made no coefficient or parameter change request, the request from sink system 40b is not in conflict with sink system 40a, so matrix manager 20 does not need to resolve a conflict. If there had been a conflict between the requests from sink system 40a and sink system 40b, matrix manager 20 would have resolved it according to a predetermined set of rules.

In the example shown in FIG. 2, it can be seen that the diagonal set of “1” coefficients in mixing grid 35 has been replaced with lesser numbers; in effect, output channels O_{A} to O_{F} have been ‘turned down’ to varying extents. Sink system 40b has also added new coefficients to the bottom two rows of mixing grid 35. In this example, these coefficients are creating a stereo mix from a 5.1 source (assuming for instance that channels 1 and 2 are front channels, channel 3 is a center channel, channels 4 and 5 are rear channels, and channel 6 is the subwoofer channel).

FIG. 3 illustrates a variant configuration of the system shown in FIG. 2. Instead of ‘turning down’ output channels O_{A} to O_{F} as sink system 40b did in FIG. 2, here sink system 40b issues a command request to bonding subsystem 10, asking it to drop bond 12a with sink system 40a. Bonding subsystem 10 complies, and bond 12a is dropped; sink system 40a thus goes quiet since audio outputs are no longer being fed to it. Note that sink system 40a can react to this lack of bond by doing ‘smart’ things such as, for example, automatically powering down its audio amplifiers to save power (and to eliminate amplifier hiss).

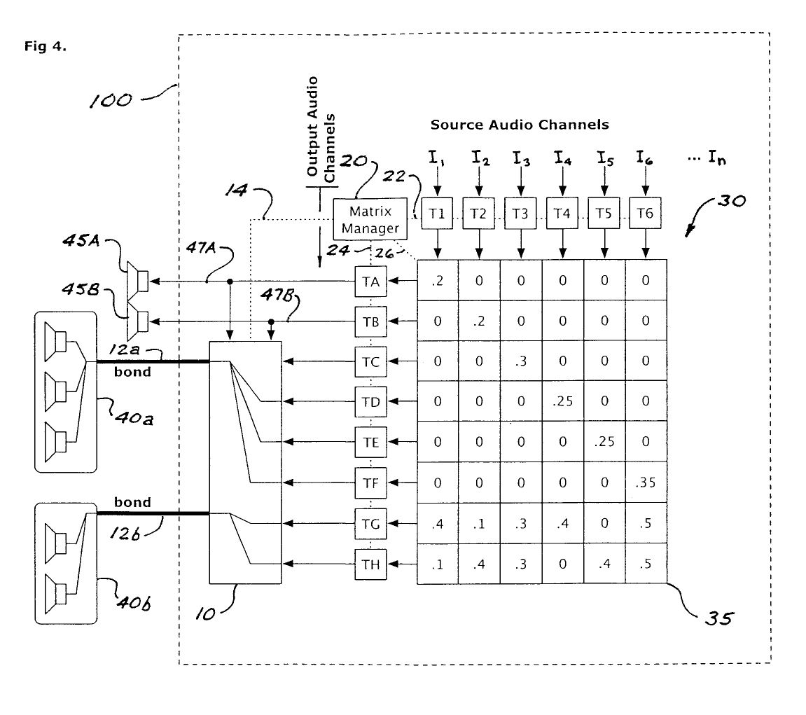

FIG. 4 illustrates that the system of the invention can also be used in conjunction with ‘non-smart’ sinks. In this example, output channels O_{A} and O_{B} are directly fed out to non-smart sinks 45A and 45B via simplex communication paths 47A and 47B. This illustrates that the invention supports simplex and smart communications links in any combination. It will be noted that output channels O_{A} and O_{B} are also made available to bonding subsystem 10, via branches of simplex communication paths 47A and 47B, in case any smart sink system should request them. It will be readily appreciated, by logical extension of this example, that any or all of the output channels could be made available both as smart outputs (via the bonding subsystem) and as simplex outputs.

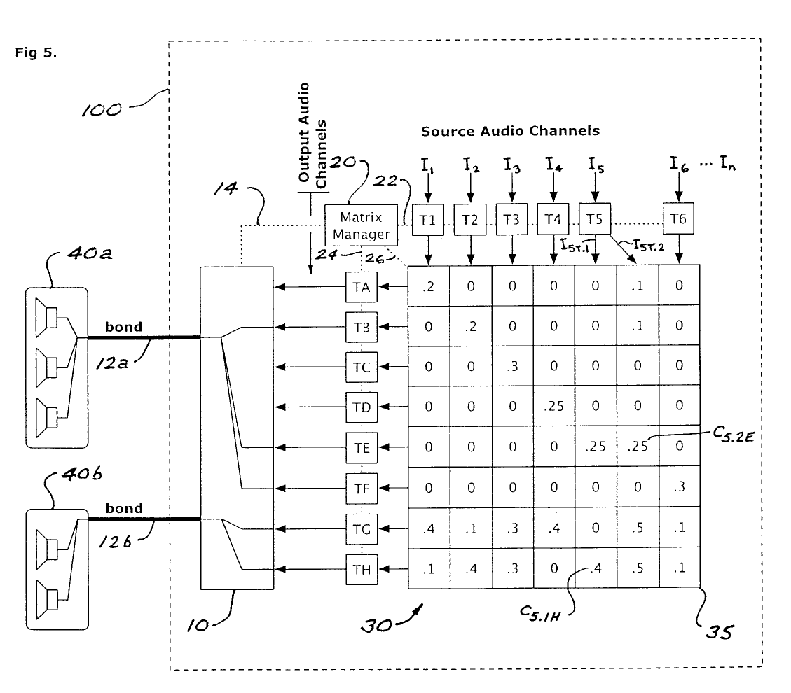

FIG. 5 illustrates that input transfer functions may have more than one output (and thereby, result in more than one corresponding column in mixing grid 35). In the illustrated case, part or all of the functionality of input transfer function T5 would need to be duplicated within its functional block, with the post-transfer outputs from input channel I₅ being referenced in FIG. 5 as I_{5T.1} and I_{5T.2}. Although this example shows this for input channel I₅ only, the concept may be applied to as many input channels as desired.

Although two outputs are shown from input transfer function T5 in the example of FIG. 5, it is also possible to have more than two outputs from a given input transfer function. For example, input transfer function T5 could start by applying two filters to input channel I₅ in a crossover arrangement, creating, for example, two signals from input channel I₅—e.g., one signal in the range of 0 to 500 Hz and the other in the range of 500 Hz to 20 kHz. Input transfer function T5 could then apply different treatment to the two newly-created signals—for example, applying chorus and EQ to the high-frequency signal and a 60 ms delay to the low-frequency signal.

The system of the present invention is adaptable for use with any combination of single-output and multiple-output transfer functions on the input transfer functions.

FIG. 6 illustrates a variant of the configuration shown in FIG. 3. Here, instead of requesting that bond 12a to sink system 40a be dropped, sink system 40b requests that bonding subsystem 10 send a command to sink system 40a, muting its outputs and powering down its power amps. In this case, since bond 12a is retained, the sound to sink system 40a can be restored nearly instantaneously (as compared to the scenario in FIG. 3, in which re-establishment of bond 12a would take significant time).

By logical extension, it will be appreciated that commands could be sent to a given sink system telling it to “turn volume down to 50%”, or any number of other possible commands, provided that the sink system is capable of executing the commands sent to it by bonding subsystem 10.

FIG. 7 illustrates an audio signal management system 200 in accordance with an alternative embodiment of the invention, in which a secondary source audio system 50 is bonded to bonding subsystem 10 via a bond 55. Secondary source system 50 makes a plurality of source audio channels E₁ to Eₚ available to system 200. An additional component referred to as a source multiplexer 60 is provided to receive audio channels E₁ to Eₚ from the secondary source audio system as well as audio channels I₁ to Iₙ from the primary source audio system, and to direct these source audio channels to mixing grid 35 as appropriate. In this embodiment, a modified matrix manager 220 (or “matrix-MUX manager”) controls the operation and management of source multiplexer 60 as well as mixer matrix 30. As conceptually illustrated in FIG. 7, matrix-MUX manager 60 is operationally connected to bonding subsystem 10 by communications link 14, to the input transfer functional blocks (T1, T2, T3, etc.) by communications link 222, to the output transfer functional blocks (TA, TB, TC, etc.) by communications link 224, to mixing grid 35 by communications link 226, and to source multiplexer 60 by link 228.

In the configuration shown in FIG. 7, audio channels E₁ and E₂ are fed from secondary source system 50 to source multiplexer 60 along with audio channels I₁ to I₆ from the primary source system. Source multiplexer 60 directs audio channels E₁ and E₂ into mixing grid 35 via input transfer functions T5 and T4 respectively, while directing audio channels Iᵢ, I₂, I₃, and I₆ mixing grid 35 via input transfer functions T1, T2, T3, and T6 respectively, with audio channels I₄ and I₅ not being used at all. In the final mix produced by mixer matrix 30, sink system 40a receives output channel O_{BT} mixed from audio channel E₂, output channel O_{CT} mixed from audio channel E₁, and output channel O_{FT} mixed from audio channels E₁ and E₂. At the same time, sink system 40b receives output channel O_{GT} mixed from audio channels I₁ and I₃, and output channel O_{HT} mixed from audio channels I₂ and I₃. FIG. 7 thus further illustrates the flexibility of the system of the present invention to serve many combinations of source audio systems and audio sink systems.

The following sections of this patent specification discuss non-limiting examples of how the audio signal management system of the present invention may be implemented and used in conjunction with entertainment systems including home theater systems.

### Scenario 1

In this scenario, six source audio channels are available from a 5.1 surround DVD movie source, for purposes of a home theater application. The system of the present invention is adapted for two operational modes, referred to as day-time mode and night-time mode. Day-time mode occurs if no headphones are bonded, and night-time mode occurs if one or more sets of headphones are bonded.

In day-time mode, no headphones are in use, output channels O_{A}, O_{B}, and O_{C} are hard wired to the front speakers (L, R, and C respectively) by simplex connection. Output channels O_{D}, O_{E}, and O_{F} are all connected to a single sink system (located, for example, behind a sofa) that contains the power supplies and amplifiers for the two rear surround speakers (left rear and right rear) as well as the subwoofer. In this scenario, the subwoofer enclosure houses the sink system, and short wires run from its enclosure to the rear surround speakers (e.g., one located on either side of the sofa). In total, three sinks are wired and three sinks are wireless (via a single sink system located in the rear). In day-time mode, the default set of coefficients is used in mixing grid 35. The default coefficients include a diagonal line of “1” coefficients, allowing source audio channel to flow through output channel O_{A}, source channel I₂ through output channel O_{B}, and so on. Upon bond-up, however, the sink system causes the output transfer functions TA, TB, and TC to load parameters introducing a 20 ms delay to the front speakers—matching the natural delay which is unavoidably introduced by the wireless sink system, thereby eliminating any undesired problems potentially arising from audio channels not being perfectly synchronized with one another.

After night falls, the user may decide that he or she does not want to disturb other people sleeping in the home. The user powers up a pair of headphones (a smart sink system with two sinks—analogous to sink system 40b in FIG. 3), and the headphones establish bond with the bonding subsystem. Upon bonding, the headphones cause the following to happen (via requests made by the headphones to the bonding subsystem):
Rows A, B, and C of mixing grid 35 are loaded with zeros (this mutes the wired front speakers);
Bond is dropped to the three-sink system (subwoofer and two rear surround speakers) that was being fed by output channels O_{D}, O_{E}, and O_{F};
The three-sink system responds to the lack of bond by powering down its audio amps; and
Rows G and H are loaded with new coefficients (as in FIG. 3), creating a stereo mix for the headphones from the 5.1 source material.

Suppose that two additional pairs of headphones are now powered up by two additional users. The additional headphones will establish bond with the bonding subsystem and will also receive the same stereo mix (from output channels O_{G} and O_{H}) that is being fed to the first set of headphones. As long as at least one pair of headphones is bonded, night-time mode continues.

When the last set of headphones is powered down (and bond is dropped), matrix manager 20 restores mixing grid 35 to its default state and allows the three-sink system (subwoofer and two rear surrounds) to re-bond; i.e., once it detects bond establishment, the three-sink system will respond by powering up its audio amps).

### Scenario 2

In this scenario, a user wishes to progressively expand a home theater system, and has a Sony Blu-Ray™ source that supplies 7.1 channels of surround sound.

In step 1 of a system expansion program, the user purchases two speakers for the home theater system. The matrix manager responds by loading the coefficients necessary to mix the eight source channels to a simple stereo mix for the two speakers.

In step 2, the user installs a subwoofer, thereby converting the system to a 2.1 system. The new mix loaded by the matrix manager disconnects the LFE (subwoofer channel) from the two front speakers, and redirects it to the new subwoofer.

In step 3, the user installs a center speaker, thus creating a 3.1 system. The center channel (3), which used to be mixed onto the left and right front speakers, is now sent to the center speaker.

In step 4, the user adds two rear surround speakers, thus creating a 5.1 speaker system, with the new mix being that the front channels (L, R, and C) are all sent to their respective speakers, as is the subwoofer. The rear sides and rear surrounds are mixed together to form the 5.1 version of the rear surrounds.

In each step of the system expansion, a different mix is generated that makes the most sense given the attributes and capabilities of the available hardware. As the upgrading progresses, the matrix manager is called on to make numerous logical decisions, and to sort out conflicting requests as necessary, all in accordance with pre-established rules.

It will be readily appreciated by those skilled in the art that various modifications of the present invention may be devised without departing from the essential concept of the invention, and all such modifications are intended to come within the scope of the present invention and the claims appended hereto. It is to be especially understood that the invention is not intended to be limited to illustrated embodiments, and that the substitution of a variant of a claimed element or feature, without any substantial resultant change in the working of the invention, will not constitute a departure from the scope of the invention.

In this patent document, the word “comprising” is used in its non-limiting sense to mean that items following that word are included, but items not specifically mentioned are not excluded. A reference to an element by the indefinite article “a” does not exclude the possibility that more than one of the element is present, unless the context clearly requires that there be one and only one such element.

### GLOSSARY

As used in this patent document, the terms, acronyms, and abbreviations listed below are intended to be understood in accordance with the indicated definitions or explanations, unless the context clearly requires otherwise. Terms not listed below and not otherwise defined in this specification are intended to have meanings as would be generally understood by persons of ordinary skill in the art of the invention.

| Term | Definition/Explanation |
|---|---|
| AC3 | The compressed, combined 6-channel digital audio stream |
| | used by Dolby ® Digital audio systems (5.1 channel audio |
| | systems, for example). |
| ADC | Analog-to-digital converter. |
| ADPCM | A low-latency compression algorithm that does not require |
| | floating point math and that is implemented in the time |
| | domain. |
| Attributes | The characteristics of a sink system as transmitted to a |
| | source audio system following bonding. For example, the |
| | sink system might transmit attributes such as the number of |
| | audio channels (e.g., 2); surround identity (e.g., rear left and |
| | rear right); dynamic range (e.g., 500 Hz to 14.5 kHz); |
| | decompression supported (yes or no); type of decompression |
| | supported (e.g., ADPCM, etc.). |
| Bond | An established communications link between a sink system |
| | and a source audio system, sufficient for transmitting one or |
| | more audio channels to the sink system. |
| Bonding | The process of creating a communications link between a |
| | sink system and a source audio system to facilitate |
| | transmission of an audio signal from the source audio system |
| | to the sink system. |
| Channel | A single audio channel with a certain frequency |
| | response. |
| Coeffi- | Multiplication coefficients loaded into the mixing grid - the |
| cients | matrix manager loads default coefficients into the mixing |
| | grid at start-up, and can replace any of them at any time |
| | (e.g., as a response to a request from a bonded sink system). |
| DAC | Digital-to-analog converter. |
| Dolby ® | Encompasses Dolby 5.1, 6.1 and 7.1; uses ACS compressed |
| Digital | data format. |
| Dolby 2.1 | Home theater surround standard promoted by Dolby |
| | Laboratories. The number 2.1 represents two speakers |
| | (200 Hz-20 kHz) and one LFE (subwoofer <200 Hz). |
| Dolby 5.1 | Home theater surround standard promoted by Dolby |
| | Laboratories; the number 5.1 represents five speakers |
| | (L, R, center, rear L, and rear R) and an LFE. |
| Dolby 6.1 | Six speakers and an LFE (adds rear center speaker to Dolby |
| | 5.1). |
| Dolby 7.1 | Seven speakers and an LFE (adds L and R side speakers to |
| | Dolby 5.1). |
| Duplex | Communication in two directions. |
| Frequency | A range of frequencies supported by an audio channel (for |
| response | example 20 Hz-20 kHz is considered a ‘full range’ (covers |
| | entire range of human hearing). |
| Gain | The increase in signal amplitude produced by an amplifier |
| | (typically measured as the mean ratio of signal output to |
| | signal input). |
| LFE | Low Frequency Effects -- the audio channel in multi-channel |
| | audio that is sent to the subwoofer. For example, the “.1” in |
| | Dolby 5.1 refers to the LFE channel. |
| Param- | Control parameters loaded into various effects blocks that |
| eters | make up each of the transfer function blocks (both input |
| | transfer functions and output transfer functions) - the matrix |
| | manager loads default parameters into all transfer functions |
| | at start-up, and can replace any of them at any time (e.g., as a |
| | response to a request from a bonded sink system). |
| Physical | In either wired or wireless systems, the RF (radio frequency) |
| layer | layer of the communication solution as implemented by the |
| | selected radio frequency transmitter, receiver, or transceivers. |
| Quality of | A term for reliability in wireless systems. In wireless audio |
| Service | systems, good QoS is very important and very difficult to |
| (QoS) | achieve since what is being transported is a real-time signal. |
| | Real-time signals are fleeting, so the transmit node cannot |
| | take whatever time is required to transmit the data - the data |
| | must be transferred as a stream to the receive node. Any |
| | break in this stream will result in dropouts or crackles/pops in |
| | the resulting audio (poor QoS). A reliable stream with no |
| | discontinuities is considered good QoS. QoS may be |
| | measured quantitatively by placing the wireless system at a |
| | fixed range in a predetermined environment and measuring |
| | MTBF (i.e., mean time between failures). |
| Simplex | Communication in one direction only. |
| Simplex | A communications link enabling an audio signal to be carried |
| wired link | over a digital or analog wired connection in one direction of |
| | communication only. |
| Simplex | A communications link enabling an audio signal to be carried |
| wireless | over a digital or analog wireless connection in one direction |
| link | of communication only. |
| Sink | A destination for a single channel of audio (e.g., a speaker or |
| | headphone driver). |
| Smart | A communications link enabling an audio signal to be carried |
| wired link | over a digital or analog wired connection using a duplex (bi- |
| | directional) communications link between a source and a |
| | sink and enabling the sink side to communicate control |
| | requests to the source side and vice versa. |
| Smart | A communications link enabling an audio signal to be carried |
| wireless | over a digital or analog wireless connection using a duplex |
| link | (bi-directional) communications link between a source and a |
| | sink and enabling the sink side to communicate control |
| | requests to the source side and vice versa. |
| Source | A source of a single channel of audio (e.g., TV, CD or DVD |
| | player, MP3 jukebox). |
| Source | A source of a multiple channels of audio. |
| Audio | |
| System | |

1. A system for managing audio signals in association with one or more source audio systems and one or more smart audio sink systems, each smart audio sink system comprising one or more audio sinks, said system for managing audio signals comprising a bonding subsystem which is adapted:
(a) to receive a plurality of audio signals from the one or more source audio systems;
(b) to receive control data transmissions from the one or more smart sink systems;
(c) to selectively establish duplex communications bonds with one or more of the smart sink systems in response to control data received therefrom; and
(d) to deliver one or more selected audio signals to one or more smart sink systems via bonds established therewith;
wherein the selection of audio signals to be delivered to the one or more smart sink systems is determined by the bonding subsystem in accordance with predetermined rules having regard to control data received from the smart sink systems.

2. A system for managing audio signals in association with one or more source audio systems and one or more smart audio sink systems, each smart audio sink system comprising one or more audio sinks, said system for managing audio signals comprising:
(a) a bonding subsystem which is adapted:
a.1 to receive a plurality of output audio signals from the one or more source audio systems;
a.2 to receive control data transmissions from the one or more smart sink systems;
a.3 to selectively establish duplex communications bonds with one or more of the smart sink systems in response to control data received therefrom; and
a.4 to deliver one or more selected output audio signals to one or more smart sink systems via bonds established therewith;
(b) a mixing grid adapted to receive source audio signals from the one or more source audio systems and to mix selected source audio signals to produce output audio signals for delivery to the bonding subsystem, based on mixing coefficients entered into the mixing grid;
(c) a matrix manager in operative communication with the bonding subsystem and the mixing grid, such that:
c.1 control data transmissions from the smart sink systems can be relayed from the bonding subsystem to the matrix manager;
c.2 the matrix manager is adapted to selectively enter mixing coefficients into the mixing grid, or change or delete mixing coefficients previously entered into the mixing grid, in accordance with predetermined rules having regard to control data received from the smart sink systems via the bonding subsystem;
wherein the selection of output audio signals to be delivered to the one or more smart sink systems is determined by the bonding subsystem in accordance with predetermined rules having regard to control data received from the smart sink systems.

3. The system of claim 2, further comprising at least one input transfer function adapted to modify a selected source audio signal prior to introduction of said selected source audio signal into the mixing grid.

4. The system of claim 2, further comprising at least one output transfer function adapted to modify a selected output audio signal prior to delivery of said selected output audio signal to the bonding subsystem.

5. The system of claim 3, further comprising at least one output transfer function adapted to modify a selected output audio signal prior to delivery of said selected output audio signal to the bonding subsystem.

6. The system of claim 3 wherein the matrix manager is adapted to control and define all parameters loaded into the at least one input transfer function, in accordance with predetermined rules having regard to control data received from the smart sink systems.

7. The system of claim 4 wherein the matrix manager is adapted to control and define all parameters loaded into the at least one output transfer function, in accordance with predetermined rules having regard to control data received from the smart sink systems.

8. The system of claim 3 wherein the at least one input transfer function is selected from the group of effects consisting of equalization, signal compression, expansion, gating, signal delay, echo, reverberation, chorusing, filters, and modification of gain levels.

9. The system of claim 4 wherein the at least one output transfer function is selected from the group of effects consisting of equalization, signal compression, expansion, gating, signal delay, echo, reverberation, chorusing, filters, and modification of gain levels.

10. The system of claim 2, further comprising a source multiplexer, said source multiplexer being adapted to receive source audio signals from two or more source audio systems and to direct selected source audio signals into the mixing grid, and wherein the matrix manager is additionally adapted to control the operations of the source multiplexer in accordance with predetermined rules having regard to control data received from the smart sink systems via the bonding subsystem.

11. A method for optimizing sound quality in a sound system providing source audio signals from one or more source audio systems for delivery to one or more smart sink systems, said method comprising the step of providing a bonding subsystem which is adapted:
(a) to receive a plurality of audio signals from the one or more source audio systems;
(b) to receive control data transmissions from the one or more smart sink systems;
(c) to selectively establish duplex communications bonds with one or more of the smart sink systems in response to control data received therefrom; and
(d) to deliver one or more selected audio signals to one or more smart sink systems via bonds established therewith;
wherein the selection of audio signals to be delivered to the one or more smart sink systems is determined by the bonding subsystem in accordance with predetermined rules having regard to control data received from the smart sink systems.

12. A method for optimizing sound quality in a sound system providing source audio signals from one or more source audio systems for delivery to one or more smart sink systems, said method comprising the steps of:
(a) providing a bonding subsystem which is adapted:
a.1 to receive a plurality of output audio signals from the one or more source audio systems;
a.2 to receive control data transmissions from the one or more smart sink systems;
a.3 to selectively establish duplex communications bonds with one or more of the smart sink systems in response to control data received therefrom; and
a.4 to deliver one or more selected output audio signals to one or more smart sink systems via bonds established therewith;
(b) providing a mixing grid adapted to receive source audio signals from the one or more source audio systems and to mix selected source audio signals to produce output audio signals for delivery to the bonding subsystem, based on mixing coefficients entered into the mixing grid;
(c) providing a matrix manager in operative communication with the bonding subsystem and the mixing grid, such that:
c.1 control data transmissions from the smart sink systems can be relayed from the bonding subsystem to the matrix manager;
c.2 the matrix manager is adapted to selectively enter mixing coefficients into the mixing grid, or change or delete mixing coefficients previously entered into the mixing grid, in accordance with predetermined rules having regard to control data received from the smart sink systems via the bonding subsystem;
wherein the selection of output audio signals to be delivered to the one or more smart sink systems is determined by the bonding subsystem in accordance with predetermined rules having regard to control data received from the smart sink systems.

13. The method of claim 12 comprising the further step of modifying at least one selected source audio signal by means of an input transfer function prior to introduction of said selected source audio signal into the mixing grid.

14. The method of claim 12 comprising the further step of modifying at least one selected output audio signal by means of an output transfer function prior to delivery of said selected output audio signal to the bonding subsystem.

15. The method of claim 13 comprising the further step of modifying at least one selected output audio signal by means of an output transfer function prior to delivery of said selected output audio signal to the bonding subsystem.

16. The method of claim 13 comprising the further step of adapting the matrix manager to control and define all parameters loaded into the at least one input transfer function, in accordance with predetermined rules having regard to control data received from the smart sink systems.

17. The method of claim 14 comprising the further step of adapting the matrix manager to control and define all parameters loaded into the at least one output transfer function, in accordance with predetermined rules having regard to control data received from the smart sink systems.

18. The method of claim 13 wherein the at least one input transfer function is selected from the group of effects consisting of equalization, signal compression, expansion, gating, signal delay, echo, reverberation, chorusing, filters, and modification of gain levels.

19. The method of claim 14 wherein the at least one output transfer function is selected from the group of effects consisting of equalization, signal compression, expansion, gating, signal delay, echo, reverberation, chorusing, filters, and modification of gain levels.

20. The method of claim 12 comprising the further steps of:
(a) providing a source multiplexer adapted to receive source audio signals from two or more source audio systems and to direct selected source audio signals into the mixing grid; and
(b) adapting the matrix manager to control the operations of the source multiplexer in accordance with predetermined rules having regard to control data received from the smart sink systems via the bonding subsystem.
